(19) United States
(12) Patent Application Publication
(10) Pub. No.: US 2013/0077143 A1
(43) Pub. Date: Mar. 28, 2013

(54) VIBRATING TILTING PLATES WITH IMPROVED DYNAMIC FLATNESS AND SHOCK RESISTANCE

(71) Applicants: Slava Krylov, Holon (IL); Avigdor Huber, Yehud (IL)

(72) Inventors: Slava Krylov, Holon (IL); Avigdor Huber, Yehud (IL)

(73) Assignee: ZODIAC UNDERWRITERS ENERGY INVESTMENTS LTD., Elkana (IL)

(21) Appl. No.: 13/609,666

(22) Filed: Sep. 11, 2012

Related U.S. Application Data
(60) Provisional application No. 61/539,491, filed on Sep. 27, 2011.

(51) Int. Cl. G02B 26/08

(52) U.S. Cl. 359/221.2

(57) ABSTRACT

Devices with tilting plates, in particular tilting mirror plates, having improved dynamic flatness and shock resistance and methods for forming and operating such devices. A mirror device includes a minor plate operative to perform a tilt motion around a mirror tilt axis and an elastic foundation which provides distributed support to the minor plate. In an embodiment, the minor plate and the elastic foundation are formed in a single silicon-on-insulator (SOI) wafer. In another embodiment, the minor plate and the elastic foundation are formed in separate SOI wafers. The elastic foundation may include spiral or serpentine or any other appropriate shaped springs distributed uniformly or non-uniformly between the minor plate and a base.

### CROSS REFERENCE TO RELATED APPLICATIONS

This application is related to and hereby claims the priority benefit of U.S. Provisional Patent Application No. 61/539,491 filed Sep. 27, 2011.

### FIELD

Embodiments disclosed herein relate generally to devices which include tilting plates and more particularly to devices which include tilting micro-minor plates and implemented in Micro Electro Mechanical Systems (MEMS) or Micro Opto Electro Mechanical Systems (MOEMS).

### BACKGROUND

Tilting plate devices, for example tilting minors implemented in MEMS or MOEMS devices are known. Such devices may exemplarily comprise rectangular, circular or elliptical plates suspended on elastic torsion members of rectangular or square cross section. FIG. 1 shows an exemplary tilting mirror 100 having a plate 102 suspended through two elastic torsion members 104 of length L_{A} on anchors 106. Plate 102 is rectangular with a thickness h, width B and length 2R and is tiltable around the torsion members (or around a “torsion axis” or “tilt axis” defined by these members) through a tilt angle θ. FIG. 2 shows initial and deformed configurations of the minor and schematics of the inertial pressure acting on the minor plate. In use, plate 102 undergoes dynamic deformation which can be separated into two components: (1) a rigid body tilting of the plate associated with angle θ, (configuration 202), and (2) dynamic deviation (“dynamic deflection”) from the planarity of the plate appearing as a result of inertial forces 204 engendered by time-dependent accelerations. The forces are indicated by arrows with varying length. The dynamic deflections are expressed by differences between the planar tilted plate configuration 202 and an actual deformed configuration 206. The accelerations are maximal at maximal tilting angles θ(t) (where t is time) when the angular velocity \dot{θ}(t) is close to zero but the acceleration is maximal. The overdot ( )=d/dt denotes derivative with respect to time. Inertial force 204 acting on plate 102 is a distributed force (i.e. force per unit area). For a thin plate and a harmonic motion such that the tilting angle is θ(t)=θ_{MAX} sin(ωt)), the inertial pressure is given by

pᵢₙₑᵣₜᵢₐₗ=ρh\ddot{θ}r=ρhω²θr (1)

Here ρ is the density of the plate material, \ddot{θ}=ω²θ is the angular acceleration, ω is the frequency of the mirror's vibrations and r is the distance between the tilting axis and the point where the pressure is calculated. The inertial pressure increases linearly with distance from the tilting axis and causes the dynamic deflection of the plate with respect to configuration 202.

Current solutions for the improvement of the dynamic flatness include mainly the incorporation of stiffeners (which is often challenging from the process point of view and manifests only limited efficiency) as well as suspension of the plate using an external frame when the torsion axis is attached not directly to the plate but to the frame. These solutions are not satisfactory.

### SUMMARY

In various embodiments there are provided tilting plates in which there is significant reduction or even complete elimination of dynamic deflections caused by inertial pressure. In some embodiments, the tilting plates are mirror plates. The following description is focused on, but by no means limited to such tilting mirrors. Tilting mirrors disclosed herein include an elastic foundation which provides distributed support of the mirror plate (referred to hereinbelow sometimes simply as “mirror” or “plate”), in contrast with the concentrated support common in the art. In some embodiments, the elastic foundation is realized as multiple springs. In some embodiments, the elastic foundation is realized as optimally located springs provided under the mirror plate. The tilting of the mirror results in the reaction (restoring pressure acting in the direction opposite to the minor plate deflection) of the elastic foundation, which increases linearly with the distance from the mirror tilt axis. Since the inertial pressure increases linearly with the distance from the axis as well, the reaction of the foundation compensates the inertial pressure at every point of the mirror plate.

In an embodiment, there is provided a device comprising a tilting plate operative to perform a tilt motion around a tilt axis and an elastic foundation which provides distributed support to the tilting plate and reduces dynamic deflections of the plate during the tilt motion, thereby improving plate dynamic flatness and shock resistance.

In an embodiment, the plate is a minor plate.

In an embodiment, the elastic foundation includes a plurality of springs.

In an embodiment, the springs are distributed uniformly relative to the plate.

In an embodiment, the springs are distributed non-uniformly relative to the plate.

In an embodiment, the non-uniform distribution provides a minimal deviation of the plate from a planar plate shape in a given integral norm.

In an embodiment, the springs are spiral.

In an embodiment, the springs have a serpentine shape.

In an embodiment, the elastic foundation includes a plurality of torsion axes and links.

In some embodiments, the device is formed in at least one silicon-on-insulator (SOI) substrate.

In an embodiment formed in at least one SOI substrate, the elastic foundation is formed in the same SOI substrate as the mirror plate.

In an embodiment formed in two SOI substrates, the elastic foundation and the mirror plates are formed in different SOI substrates.

In an embodiment, the elastic foundation has a stiffness per unit area p_{elastic} which balances exactly a plate inertial pressure pᵢₙₑᵣₜᵢₐₗ such that p_{elastic}−p_{inertial·}=0.

In an embodiment, there is provided a method for improving the dynamic flatness and shock resistance of a device which includes a tilting plate, the method comprising the steps of providing an elastic foundation and rotating the plate around a tilt axis while the elastic foundation interacts mechanically with the tilting plate to reduce dynamic deflections of the plate during the tilt motion, thereby improving the dynamic flatness of the tilting plate and improving the device shock resistance.

In an embodiment of the method, the device is a tilting mirror and the plate is a minor plate.

### BRIEF DESCRIPTION OF THE DRAWINGS

Non-limiting embodiments are herein described, by way of example only, with reference to the accompanying drawings, wherein:

FIG. 1 shows a conventional configuration of a tilting minor plate suspended using elastic torsion members;

FIG. 2 shows initial and deformed configurations of the mirror and schematics of the inertial pressure acting on the mirror plate;

FIG. 3 shows schematically an embodiment of a tilting mirror device disclosed herein, in two configurations, (A) un-deformed and (B) deformed;

FIG. 4 shows schematics of the mirror and of the supporting springs located under the minor: (A) spiral springs and (B) serpentine springs;

FIGS. 5A-D show stages in an exemplary fabrication process of springs of the embodiment in FIG. 4;

FIG. 6 shows schematics of a serpentine spring and clamped-guided beams connected in series;

FIGS. 7A-D show schematically stages in the realization of yet another embodiment of the elastic foundation in a tilting mirror disclosed herein;

FIGS. 8A, B show schematically stages in the realization of yet another embodiments of the elastic foundation in a tilting mirror disclosed herein;

FIG. 9 shows schematically yet another embodiment of a tilting minor disclosed herein.

### DETAILED DESCRIPTION

Returning now to the drawings, FIG. 3 illustrates schematically an embodiment of a tilting device (exemplarily a tilting minor) 300 disclosed herein, in two configurations: (A) un-deformed and (B) deformed. Mirror 300 includes in addition to a plate 302 which tilts around two torsion members (or tilt axis) 304, a substrate 306 and an elastic foundation 308. The substrate may be for example a handle layer of a silicon-on-insulator (SOI) wafer. In device 300, the elastic foundation is formed using a plurality of springs 310.

In use, FIG. 3C, the foundation provides distributed elastic forces acting on the minor plate in a way which prevents dynamic deflections. The deflection of every point of the plate (considered to be a rigid body) is linearly proportional to the distance from the tilting axis. The reaction of the foundation at each point (under the assumption of the small tilting angles), which can be viewed as a pressure of the elastic foundation with units N/m² acting on the plate is

p_{elastic}=kθr (2)

where k [N/m³] is the stiffness of the elastic foundation. Consequently, the total pressure acting at each point of the plate is

pᵢₙₑᵣₜᵢₐₗ−p_{elastic}=ρhω²θr−kθr=(ρhω²−k)θr (3)

Therefore, by choosing the stiffness of the foundation per unit area to be k=ρhω² it is possible to eliminate the dynamic deflection of the plate (i.e. cause p_{elastic}−pᵢₙₑᵣₜᵢₐₗ to be zero).

A simple physical explanation of this phenomenon is as follows: during free or forced resonant vibrations, the inertial forces, which are a harmonic function a time, should be dynamically equilibrated by the elastic forces. In the case of the simplest single degree of freedom mass-spring system, this “dynamic equilibrium” is satisfied at all times in the point representing the mass. In the case of a system with distributed parameters (continuous elastic system) such as a micro-minor plate, the inertial forces are applied to the plate whereas most of the elastic restoring forces are concentrated in the vicinity of the tilt axis. To compensate for the lack of the elastic forces within the area of the minor plate, these elastic restoring forces are produced by the dynamic bending of the plate. By distributing the elastic support forces over the plate area, the necessity for the mirror plate to bend (to balance the inertial forces as explained above) is eliminated.

Consider now the dynamics of the tilting motion of the mirror. The equation of the free vibrations of the plate is

I\ddot{θ}+Kθ=0 (4)

The inertial mass moment I of a rectangular plate with thickness h, width B and length 2R is I=ρhB(2R)³/12=2ρhBR³/3. The overall equivalent torsional stiffness K of the elastic foundation is calculated by integrating the moment dM created by the reaction of the elastic foundation (acting on an elementary area in the shape of a strip of the area Bdr oriented in parallel to the tilting axis) around the axis of the minor

$$dM = k θ {r}^{2} B dr \\ M = {\int }_{- R}^{R} d M = \frac{k θ {r}^{3} B}{3} {\vert}_{- R}^{R} = \frac{2 k θ {R}^{3} B}{3} = K θ \qquad ( 5 )$$

The equivalent torsion stiffness of the elastic foundation is K=2kBR³/3. The natural frequency of the tilting motion is

$$ω = \sqrt{\frac{K}{I}} = \sqrt{\frac{2 {kBR}^{3}}{3} \times \frac{3}{2 ρ h {BR}^{3}}} = \sqrt{\frac{k}{ρ h}} \to k = ρ h {ω}^{2} \qquad ( 6 )$$

We see therefore that the stiffness of the elastic foundation which satisfies the resonant condition also automatically satisfies the condition of zero total pressure (and consequently zero dynamic deflection) at all times. Note that in the case of a thin plate, the frequency of the tilting motion is identical also to the frequency of the up and down piston motion of the minor. However, for a small but finite thickness of the plate, additional rotational inertia leads to a certain decrease of the tilting frequency. As a result, the tilting frequency is a lowest frequency of the system, as desired.

In addition to improving the dynamic flatness, the distributed support also improves significantly the robustness of the minor and its sustainability against mechanical shock. In a conventional configuration such as that of mirror 100, the inertial force due to the shock acts mainly on the minor plate (the largest mass of the system), while the stiffness is provided by the torsion members. That is, the result of the inertial force and the result of the support elastic force are spatially separated and are applied to the minor plate at two different points. In the case of the distributed elastic support, the inertial force originating in the shock and acting on each infinitesimal element of the mirror is equilibrated by the distributed support elastic force acting on the same element. As a result, no bending moments arise in the mirror plate and the minor plate is not deformed under the shock.

Realization of an Elastic Foundation with a Uniform Constant Stiffness

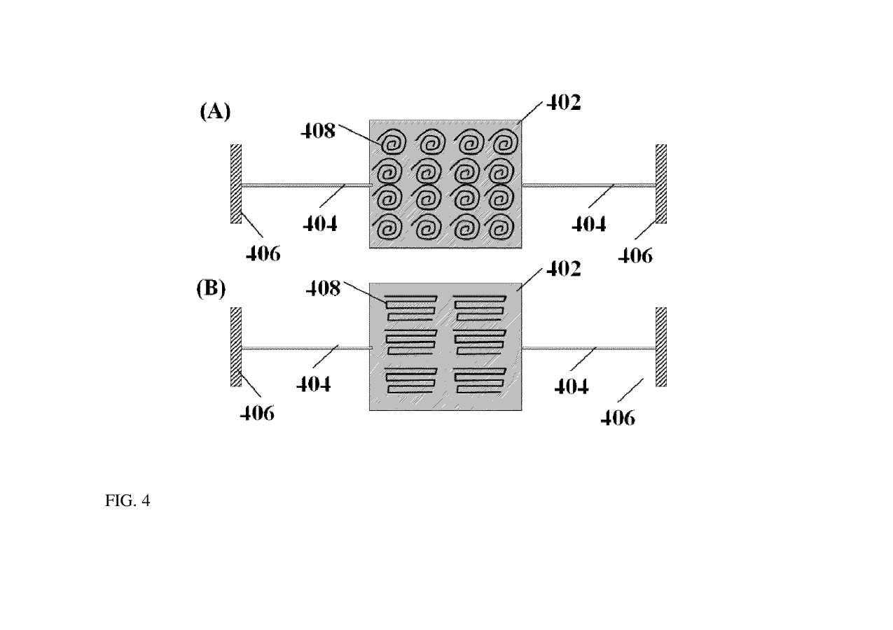

The distributed elastic foundation can be realized by several approaches and, in MEMS or MOEMS, within the framework of the limitations of existing micro-fabrication processes. One possible realization (embodiment) is illustrated in FIGS. 4A, B. A mirror plate 402 is attached to anchors 406 by two low torsional stiffness (long and thin) members 404. An array of springs 408 is provided under the mirror plate. Exemplarily, each spring may have a traditional spiral shape, FIG. 4A, or a serpentine shape, FIG. 4B. The springs can be fabricated from the thin device layer of a SOI wafer with a tensile layer (e.g. of chromium or silicon nitride) deposited on top of each spring, using processes known in the art. If the number of springs is large enough, they can be viewed effectively as a uniform elastic foundation with a constant stiffness per unit area.

Note that the distribution of the springs (or of any other type of elastic foundation member that fulfills the function of providing improving minor dynamic flatness and shock resistance) may be uniform or non-uniform. A non-uniform distribution may be chosen in such a way that the dynamic deflection of the plate is minimal in a certain norm. As an example of the flatness criterion, one can use the following expression

$${min}_{A} {\int }_{A} {( w - r θ )}^{2} d A$$

where w is the dynamic deflection of the plate and A is the plate area.

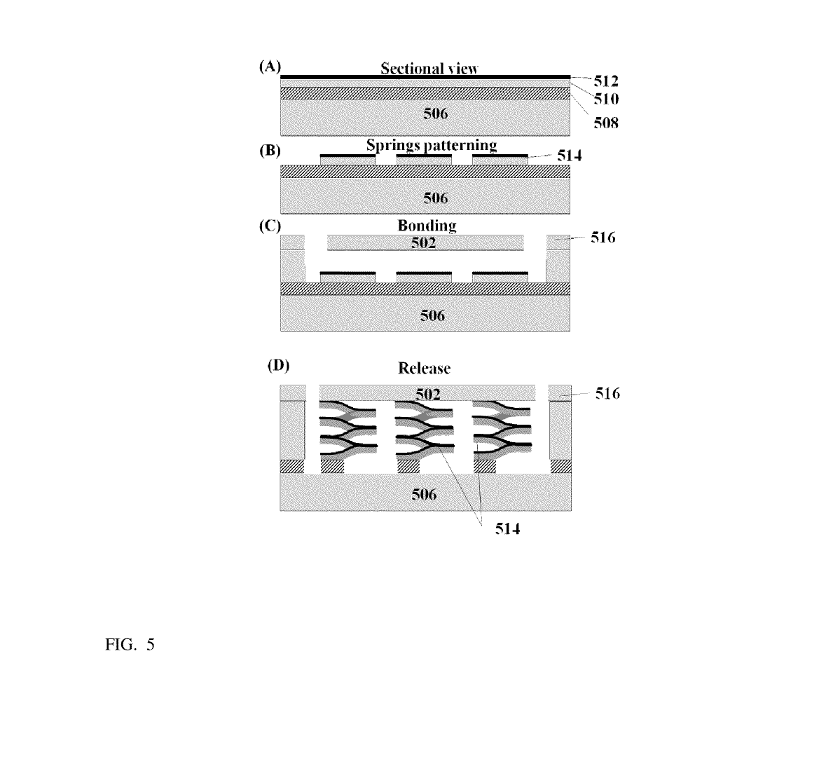

FIGS. 5A-D show stages in an exemplary fabrication process of springs of the embodiment in FIG. 4. The starting material, FIG. 5A, includes a first SOI (“mirror”) wafer with a handle layer 506 and a thin device layer 510 separated from the handle by a buried oxide (BOX) layer 508. The device layer is covered by a highly stressed layer 512 (e.g. made of silicon nitride or chromium). Springs 514 are patterned first using deep reactive ion etching (DRIE), with the etch stop in the BOX layer, FIG. 5B. Then, a mirror plate 502 is patterned using a device layer 516 of a second SOI wafer. The mirror wafer is then bonded face down to the second SOI wafer with previously patterned springs, FIG. 5C. Springs 514 are released using hydrofluoric acid (HF). Due to high residual stress in layer 512, the released springs are bent up, forming a spatial structure which contacts the mirror plate, FIG. 5D.

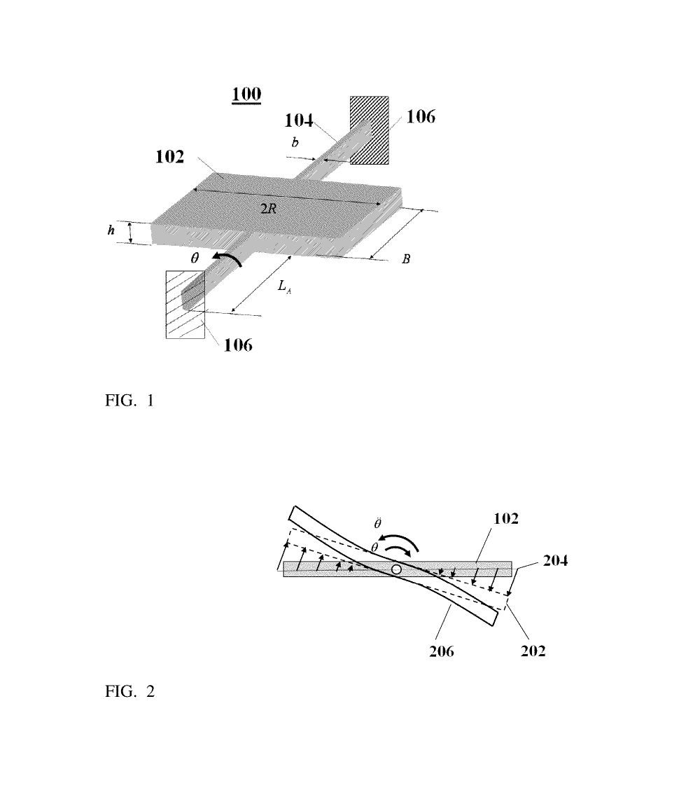

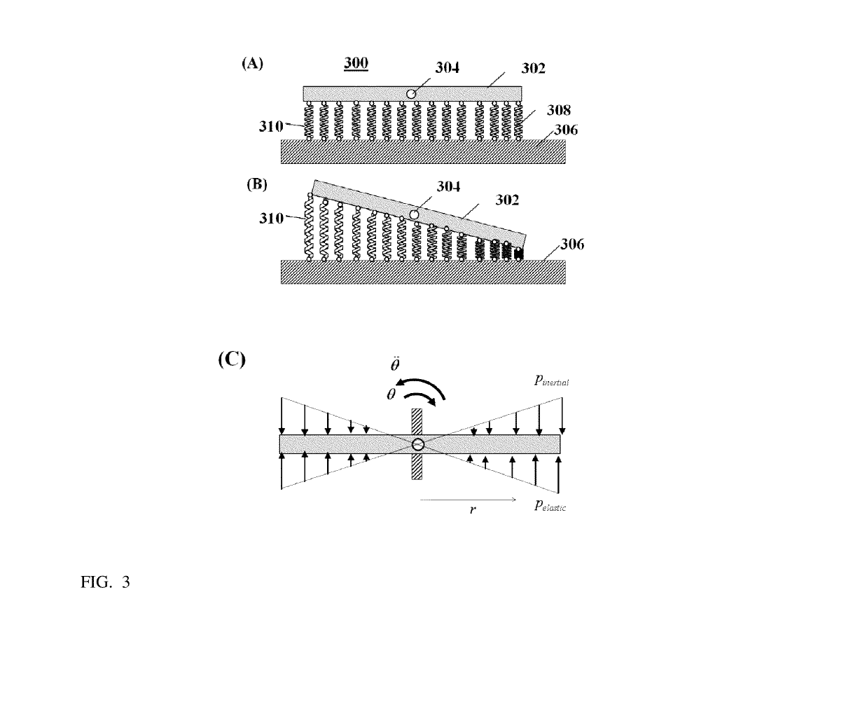

Exemplary parameters of the springs are calculated next. First, we calculate the stiffness of the elastic foundation required to achieve the desired frequency. Consider a first exemplary minor with a square plate of dimensions 1700×1700 μm² and thickness h of 30 μm. In this case, B=1700 μm and R=850 μm (see FIG. 1). In accordance with Eqs. (3) and (6), we have k=ρhω²=4π²ρhf² where f is the natural frequency of the mirror. For the parameters above, ρ=2300 kg/m³ and f=24 kHz, and the required stiffness of the elastic foundation is k=1.6×10⁹ N/m³.

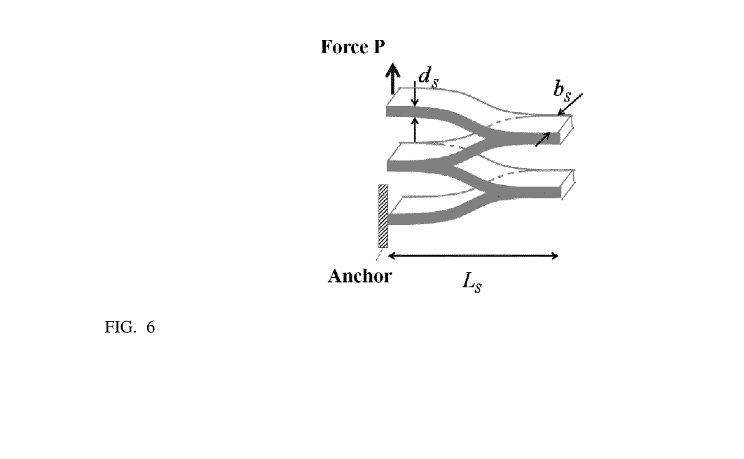

Assume for simplicity that the elastic foundation is built from serpentine springs, FIG. 4B. Each spring can be viewed as several clamped-guided beams connected in series, see FIG. 6 The width, thickness and length of each segment of a spring are respectively bₛ, dₛ and Lₛ. The thickness of the stressed film is d_{f}. The stiffness kₛ⁽ⁱ⁾ of each segment of the serpentine spring (viewed as a clamped-guided beam) and the stiffness kₛ of the entire assembly are respectively

$${k}_{S}^{( i )} = \frac{12 EI}{{L}_{S}^{3}} = \frac{{{Eb}_{S} ( {d}_{S} + {d}_{f} )}^{3}}{{L}_{S}^{3}} ; \\ {k}_{S} = \frac{{k}_{S}^{( i )}}{n} = \frac{{{Eb}_{S} ( {d}_{S} + {d}_{f} )}^{3}}{{nL}_{S}^{3}} \qquad ( 7 )$$

We calculate the curvature of each element of the spring due to the residual stress in the intentionally deposited stressed film (e.g., silicon nitride or chromium). In accordance with the well known Stoney formula (written here for the one-dimensional case of a beam rather than a plate), we have

$${ρ}_{S} = \frac{{E}_{S} {d}_{S}^{2}}{6 {σ}_{f} {d}_{f}} \qquad ( 8 )$$

Here ρₛ is the beam radius of curvature, Eₛ is the beam Young's modulus, dₛ and d_{f} are respectively the thicknesses of the beam (spring) and of the stressed film, and σ_{f} is the residual stress in the film. The elevation of the end of each segment of the spring is

$${w}_{S}^{( i )} = {ρ}_{S} [ 1 - cos ( α ) ] = {ρ}_{S} [ 1 - cos ( \frac{{L}_{S}}{{ρ}_{S}} ) ] \qquad ( 9 )$$

where Lₛ is the length of the segment, see FIG. 6.

In an exemplary design, assume that each serpentine spring is assembled from n=10 segments, each segment being Lₛ=180 μm long, bₛ=18 μm wide and dₛ=8 μm thick. The area of the spring is Lₛ×n×bₛ=180×180 μm². The thickness of the film and the stress are respectively d_{f}=2 μm and σ_{f}=1000 MPa. Young's modulus of the spring material (Si) is 169 GPa. We assume for simplicity that the film has the same Young's modulus (although the actual modulus of silicon nitride is usually higher than that of Si). In this case we obtain that the stiffness of the spring is kₛ=52.1 N/m and the stiffness of the elastic foundation is k=kₛ/Area=52.1 N/m/(180×180 μm²=1.6×10⁹ N/m³, as required. Equation (9) yields the deflection wₛ of the end of the spring of wₛ=nwₛ⁽ⁱ⁾=179 μm. This result implies that the end point of the mirror is able to deflect up to 180 μm without contact with the substrate, which is equivalent to a mechanical angle of 0.21 rad=12.1 degree.

The calculations presented here provide only a simple estimation and are exemplary. Careful design and optimization of the spring may allow significant improvement of the results. In an alternative embodiment, the design may be such that the elastic foundation provides only a part of the total tilting stiffness, with another part of this stiffness originating in the torsion axis. In yet another embodiment, the design may include an elastic foundation with variable stiffness. The part of the mirror plate closer to the tilting axis deflects much less in the vertical direction and stiffer springs may be used there. The springs located further away from the axis may be weaker, thus allowing larger deflection of the mirror.

Consider now another (second) exemplary mirror of dimensions 3000×3000×530 μm³, where the thickness of the mirror plate is 50 μm. In this case we have B=3000 μm and R=1500 μm (see FIG. 1). Assume that each segment of the serpentine spring is Lₛ=300 μm long, bₛ=20 μm wide and dₛ=6 μm thick. The area of the spring is Lₛ×n×bₛ=300×200 μm². The thickness of the film and the stress are d_{f}=0.5 μm and σ_{f}=1000 MPa, respectively. For the adopted parameters, ρ=2300 kg/m³ and f=2.5 kHz, obtain that the required stiffness of the elastic foundation is k=2.8×10⁷ N/m³. Equation (7) gives for these mirror parameters k=kₛ/Area=2.6×10⁷ N/m³, which is close to the required value. Equation (9) yields the deflection of the end of the spring of wₛ=nwₛ⁽ⁱ⁾=332 μm. This result implies that the end point of the mirror is able to deflect up to 332 μm without contact with the substrate, which is equivalent to the mechanical angle of 0.22 rad=12.7 degree for the 3 mm wide mirror.

We now analyze the behavior of this mirror in the case of mechanical shock. First note that the curvature of the springs arises due to the release of the tensile residual stress in the silicon nitride layer and the appearance of the compressive stress in the beam itself. The full flattening of the beam will result in the restoration of the original tensile stress in the nitride layer and zero stress in the Si layer. From this perspective, the stress in a spring cannot exceed an initial “as fabricated” value. The full flattening of a spring is accompanied by contact of the spring with the substrate, which prevents the mechanical failure of the structure.

The balance between the potential and kinetic energy of the mirror plate yields

mgH=1/2mv²→v=\sqrt{2gH} (10)

where H=1 m is the height that the device is dropped from. The balance between the kinetic energy of the mirror at the end of the drop and the potential energy of the elastic foundation is

1/2mv²=1/2k×Area_{Mirror}w_{Max}² (11)

where w is the maximal deflection due to the drop, k is the stiffness of the elastic foundation ([N/m³]) and v is given by Eq. (10). For the parameters of this mirror, we get w_{MAX}=290 μm. That is, the full flattening of the springs is not reached. Note that this estimation is very conservative, since it disregards the presence of additional springs holding the mirror plate and assumes an ideally “rigid” contact after the drop. The result can be improved by using a variable stiffness elastic foundation in which the stiffness closer to the tilting axis is higher than at the outer part of the minor. In the case of the minor with the higher frequency of 24 kHz the deflection due to the 1 m drop is much smaller and is 28 μm.

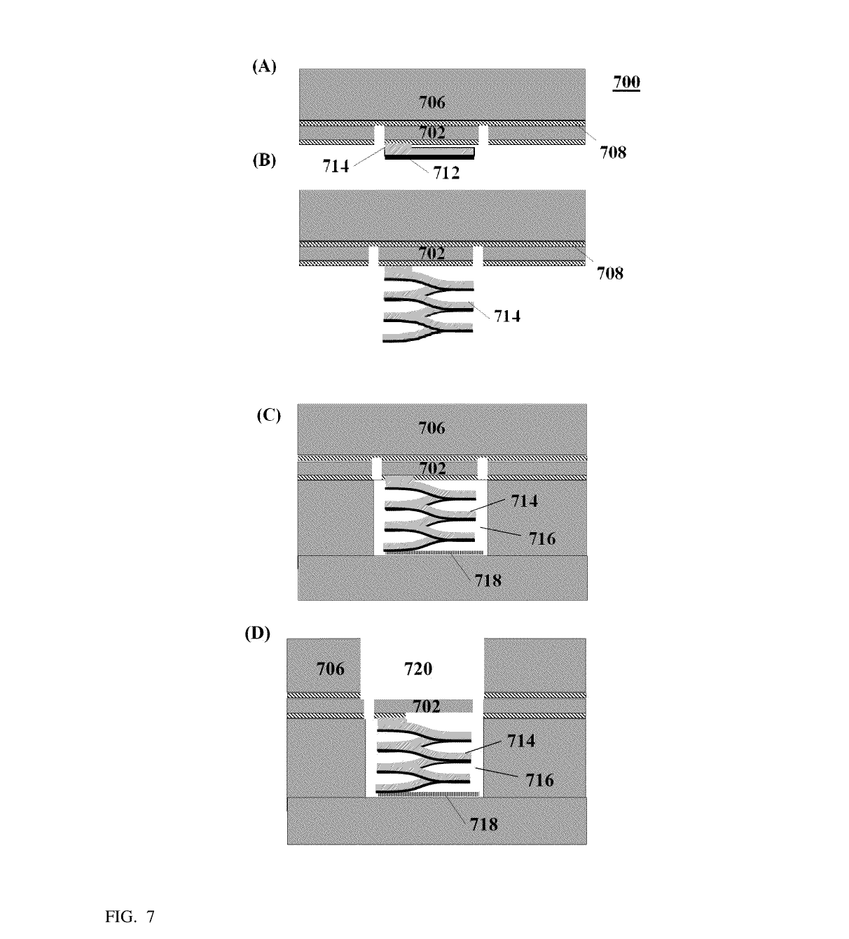

FIGS. 7A-D show schematically various stages in the realization of yet another embodiment of the elastic foundation in a tilting mirror 700. In this embodiment, springs 714 are fabricated of polysilicon (covered by a stressed layer 712) and are grown on a mirror plate 702 of a first SOI wafer, FIG. 7A. The springs are released using hydrofluoric acid, FIG. 7B. An adhesive layer (polymer, low melting temperature metal) 718 is deposited (e.g. using a shadow mask) at the bottom of a cavity 716, etched into another wafer, FIG. 7C. Release of the springs is followed by heating of the assembly and bonding of the springs to the bottom of the cavity. An opening 720 is then etched into a handle layer 706 of the first SOI wafer to expose the optical surface of the minor plate, FIG. 7D.

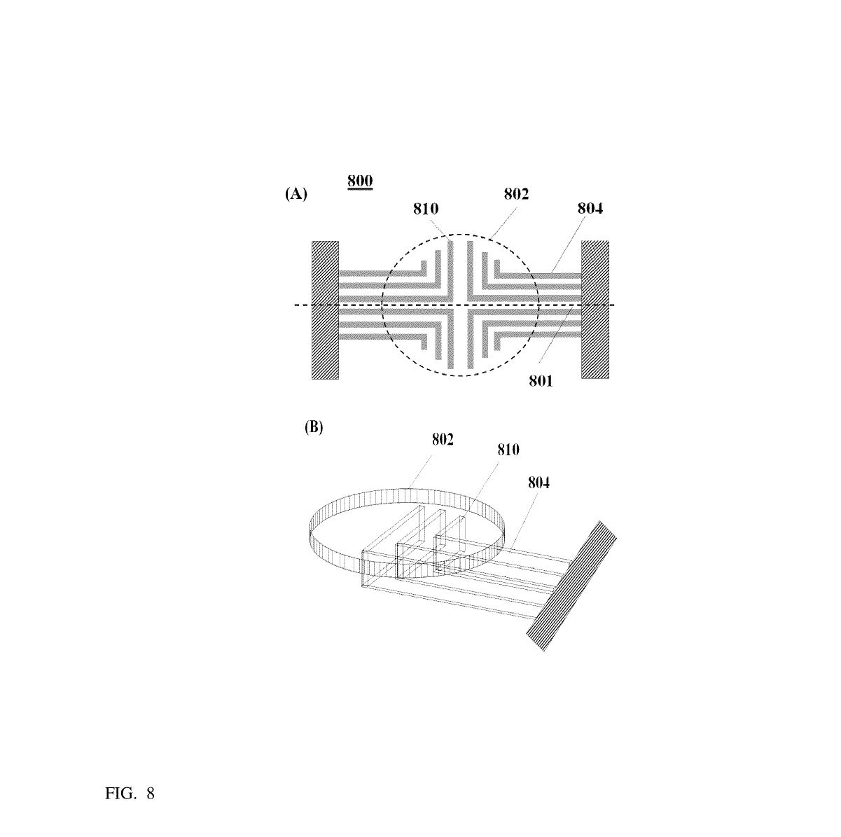

FIGS. 8A, B shows stages in the realization of yet another embodiment of the elastic foundation in a tilting mirror 800 disclosed herein. In this embodiment, an elastic foundation is attached to a minor plate 802 and is formed by an array of torsional springs 804 with low torsional stiffness and links 810 arranged in the direction perpendicular to a direction 801 of a tilting axis 804, FIG. 8A. A serpentine-like geometry as in FIGS. 4, 5 can be implemented to reduce the overall torsional stiffness of the springs. An isomeric view of the elastic foundation realized as an assembly of torsional springs and links is shown in FIG. 8B.

In yet another embodiment (not shown), a finite number of springs is provided instead of a distributed elastic foundation. The springs are optimally located to provide highest dynamic flatness and appropriate resonant frequency. Each of the springs is attached to a bending flexure or torsional spring to provide a necessary stiffness in the up and down direction.

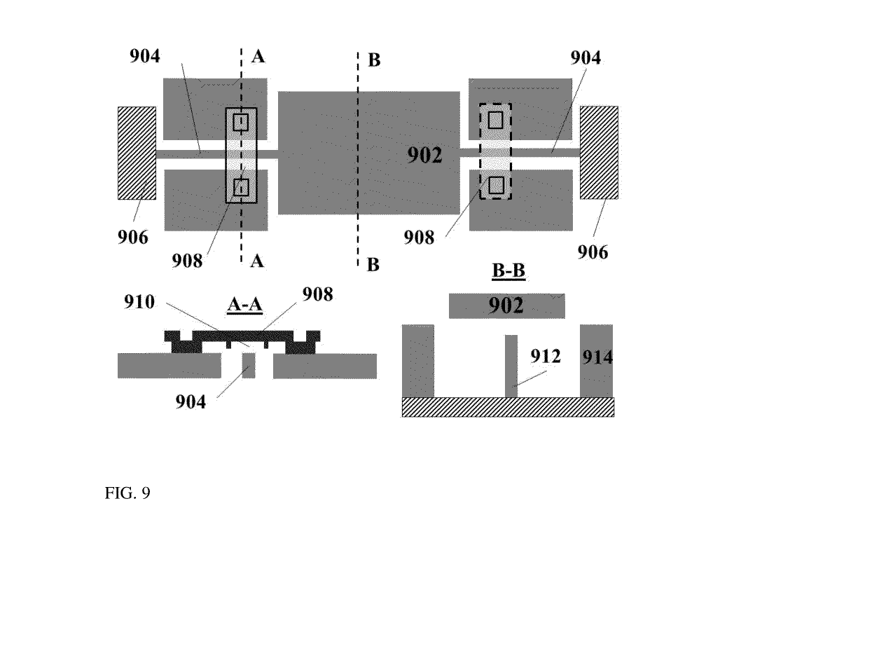

In yet another embodiment, shown in FIG. 9, a mirror 902 is attached to anchors 906 by two torsion members 904. A bridge 908 is provided above torsion members 904. A gap 910 left between the torsion members and the bridge ensures that there is no contact between them during normal operation of the minor. In the case of high inertial out-of-plane forces arising due to shock, the bridge prevents the excessive out-of-plane deformation of the structure and its failure. The bridge may be fabricated from a material such as polysilicon, metal or polymer (e.g. PDMS) using surface micromachining. Combined with a post 912 etched into the handle 914 of the wafer and fabricated using DRIE and located under the mirror or under the torsion members, the bridge provides protection against shock in all possible directions.

While this disclosure has been described in terms of certain embodiments, alterations and permutations of the embodiments will be apparent to those skilled in the art. Specifically, while the description focused in detail on tilting mirrors, non-minor tilting plates may also advantageously have improved dynamic flatness and shock resistance through the addition and use of elastic foundations disclosed herein, as long as equation 3 is fulfilled (foundation stiffness leading to zero total pressure). The disclosure is to be understood as not limited by the specific embodiments described herein, but only by the scope of the appended claims.

1. A device comprising:
a) a tilting plate operative to perform a tilt motion around a tilt axis; and
b) an elastic foundation which provides distributed support to the tilting plate and reduces dynamic deflections of the plate during the tilt motion, thereby improving plate dynamic flatness and shock resistance.

2. The device of claim 1, wherein the plate is a mirror plate.

3. The device of claim 2, wherein the elastic foundation includes a plurality of springs.

4. The device of claim 3, wherein the springs are distributed uniformly relative to the mirror plate.

5. The device of claim 3, wherein the springs are distributed non-uniformly relative to the minor plate.

6. The device of claim 5, wherein the non-uniform distribution provides a minimal deviation of the mirror plate from a planar plate shape in a given integral norm.

7. The device of claim 3, wherein the springs have a spiral shape or a serpentine shape.

8. The device of claim 2, formed using at least one silicon-on-insulator (SOI) substrate.

9. The device of claim 8, wherein the elastic foundation is formed in the same SOI substrate as the minor plate.

10. The device of claim 8, wherein the at least one SOI substrate includes two SOI substrates and wherein the elastic foundation and the mirror plates are formed in different SOI substrates.

11. The device of claim 1, wherein the elastic foundation has a stiffness per unit area p_{elastic} which balances exactly a plate inertial pressure pᵢₙₑᵣₜᵢₐₗ such that p_{elastic}−p_{inertial·}=0.

12. A method for improving the dynamic flatness and shock resistance of a device which includes a tilting plate, the method comprising the steps of:
a) providing an elastic foundation; and
b) tilting the plate around a tilt axis while the elastic foundation interacts mechanically with the tilting plate to reduce dynamic deflections of the plate during the tilt motion, thereby improving the dynamic flatness of the tilting plate and improving the device shock resistance.

13. The method of claim 12, wherein the plate is a mirror plate.

14. The method of claim 13, wherein the step of providing an elastic foundation includes providing a plurality of springs.

15. The method of claim 13, wherein the providing a plurality of springs includes distributing the plurality of springs uniformly relative to the mirror plate.

16. The method of claim 13, wherein the providing a plurality of springs includes distributing the plurality of springs non-uniformly relative to the mirror plate.

17. The method of claim 13, wherein the providing a plurality of springs includes providing a plurality of springs having a spiral shape or a serpentine shape.

18. The method of claim 13, wherein the mirror plate is formed in a silicon-on-insulator (SOI) substrate and wherein the step of providing an elastic foundation includes forming the elastic foundation in the same SOT substrate as the mirror plate.

19. The method of claim 13, wherein the minor plate is formed in a first silicon-on-insulator (SOI) substrate and wherein the step of providing an elastic foundation includes forming the elastic foundation in a second SOI substrate different from the first SOI substrate.

20. The method of claim 12, wherein the elastic foundation has a stiffness per unit area p_{elastic} which balances exactly a plate inertial pressure pᵢₙₑᵣₜᵢₐₗ such that p_{elastic}−p_{inertial·}=0.
